(19) United States
(12) Patent Application Publication
(10) Pub. No.: US 2018/0106303 A1
(43) Pub. Date: Apr. 19, 2018

(54) SWITCHABLE OR TWO-SPEED ENGINE ACCESSORY

(71) Applicant: BorgWarner Inc., Auburn Hills, MI (US)

(72) Inventors: Benjamin SPRYGADA, Battle Creek, MI (US); Steven A. BEYERSDORF, Battle Creek, MI (US)

(21) Appl. No.: 15/784,253

(22) Filed: Oct. 16, 2017

Related U.S. Application Data
(60) Provisional application No. 62/409,468, filed on Oct. 18, 2016.

(51) Int. Cl. F16D 27/09; F02B 77/14; F16H 9/04; F16D 27/14

(52) U.S. Cl. CPC F16D 27/09; F02B 77/14; F16D 2027/008; F16D 27/14; F16H 9/04

(57) ABSTRACT

An engine accessory with a wrap spring clutch, which is configured for selectively transmitting rotary power between a drive member and a shaft, and an actuator that is configured to selectively control the clutch. The actuator has first and second rotary flux elements, a clutch control ring and an electromagnet. The first rotary flux element is rotatably coupled to the drive member and has a plurality of first teeth that are spaced circumferentially about the rotary axis. The clutch control ring is rotatable about the rotary axis and is coupled to the tang of the wrap spring. The second rotary flux element is rotatably coupled to the clutch control ring. The second rotary flux element has a plurality of second teeth that are spaced circumferentially about the rotary axis. The electromagnet is selectively operable to generate a magnetic field that is transmitted between the first and second teeth.

### CROSS-REFERENCE TO RELATED APPLICATIONS

This application claims the benefit of U.S. Provisional Patent

Application No. 62/409,468 filed Oct. 18, 2016, the disclosure of which is incorporated by reference as if fully set forth in detail herein.

### FIELD

The present disclosure generally relates to a switchable or two-speed engine accessory, such as a water pump, having a radial actuation mechanism for controlling a clutch.

### BACKGROUND

This section provides background information related to the present disclosure which is not necessarily prior art.

Switchable (i.e., ON/OFF) and two-speed engine accessories, such as water pumps, are known in the art. Many of the known switchable and two-speed engine accessories employ an actuator for controlling activation or deactivation of a clutch having various friction elements that contact one another. Many of these actuators are configured with an armature that is movable along the rotational axis of the clutch. These configurations can have several drawbacks.

For example, such actuators typically require axial space along the rotational axis of the clutch that is needed to disengage the friction elements from one another. The axial space needed for disengagement of the friction elements necessarily elongates the engine accessory along the rotational axis of the clutch, which may be undesirable in some situations. As another example, engagement of the friction elements with one another can create dust and debris that can affect the performance of some clutches.

### SUMMARY

This section provides a general summary of the disclosure, and is not a comprehensive disclosure of its full scope or all of its features.

In one form, the present disclosure provides an engine accessory that includes a housing, a shaft, a drive member, a clutch and an actuator. The shaft is received in the housing and is rotatable relative to the housing about a rotary axis. The drive member is disposed about the shaft for rotation about the rotary axis. The clutch that is operable in a first clutch mode, which permits rotation of the drive member relative to the shaft in a first rotational direction, and a second clutch mode in which the shaft is coupled to the drive member for common rotation about the rotary axis. The clutch has a wrap spring with an input end, an output end and a tang. The input end includes a plurality of first helical coils that are drivingly engaged to a clutch input surface that is coupled to the drive member for common rotation. The output end has a plurality of second helical coils. The tang is formed on an axial side of the output end that is opposite the input end such that all of the second helical coils are disposed between the tang and the input end. The actuator has a first rotary flux element, a clutch control ring, a second rotary flux element, and an electromagnet. The first rotary flux element is coupled to the drive member for common rotation and has a plurality of first teeth that are spaced circumferentially about the rotary axis. The clutch control ring is rotatable about the rotary axis and is coupled to the tang of the wrap spring. The second rotary flux element is coupled to the clutch control ring for rotation therewith about the rotary axis. The second rotary flux element has a plurality of second teeth that are spaced circumferentially about the rotary axis. The electromagnet is selectively operable to generate a magnetic field that is transmitted between the first and second teeth.

In a further form, the second teeth are disposed concentric with the first teeth such that at least a portion of the first teeth and at least a portion of the second teeth overlap one another in an axial direction along the rotary axis. Optionally, the first teeth extend along the rotary axis in their entirety, and wherein the second teeth extend along the rotary axis in their entirety. Optionally, the first teeth, or the second teeth, or both the first teeth and the second teeth are generally L-shaped. Also optionally, the second teeth are disposed radially inwardly of the first teeth.

In a further form, the actuator includes a flux guide that is disposed between the electromagnet and at least one of the first teeth and the second teeth. Optionally, the flux guide has first and second circumferentially extending guide members that at least partly overlap the first and second teeth in an axial direction along the rotary axis, wherein the first circumferentially extending guide member is disposed radially inwardly of the first and second teeth, and wherein the second circumferentially extending guide member is disposed radially outwardly of the first and second teeth. A plurality of windows can be formed in the flux guide, wherein each of the windows extends about a portion of a circumference of the flux guide. The flux guide can be coupled to the drive member for common rotation about the rotary axis.

In a further form, the clutch input surface is an outer diametrical surface. Optionally, the second helical coils are configured to engage a clutch output surface when the clutch is operated in the second clutch mode, the clutch output surface being coupled to the shaft for common rotation about the rotary axis.

In a further form, the second helical coils are configured to engage a clutch output surface when the clutch is operated in the second clutch mode and wherein the second helical coils are configured to disengage the clutch output surface when the magnetic field is not produced by the electromagnet. Optionally, the first helical coils are formed to a first diameter, the second helical coils are formed to a second diameter and the first diameter is smaller than the second diameter.

In a further form, the drive member is configured to engage an endless power transmission element. Optionally, the drive member is a pulley.

In a further form, the engine accessory includes an impeller coupled to the shaft for rotation therewith.

In a further form, the engine accessory includes first and second bearings, wherein the first bearing is mounted to the housing and supports the drive member for rotation about the rotary axis, wherein the second bearing is mounted to the housing and supports the shaft for rotation about the rotary axis, and wherein the first bearing overlaps at least a portion of the second bearing in an axial direction along the rotary axis.

In a further form, the electromagnet is non-rotatably coupled to the housing.

In a further form, the tang extends radially outwardly from the second helical coils.

In a further form, a bushing is disposed between the clutch input surface and the shaft.

In further form, the first rotary flux element comprises a plurality of discrete tooth sets that are fixedly coupled to the drive member.

In another form, the present disclosure provides a method for operating an engine accessory that has a housing, a shaft, a drive member and a clutch. The shaft is received in the housing and is rotatable relative to the housing about a rotary axis. The drive member is disposed about the shaft for rotation about the rotary axis. The clutch is operable in a first clutch mode, which permits rotation of the drive member relative to the shaft in a first rotational direction, and a second clutch mode in which the shaft is coupled to the drive member for common rotation about the rotary axis. The clutch has a wrap spring with an input end, an output end and a tang. The input end has a plurality of first helical coils that are drivingly engaged to a clutch input surface that is coupled to the drive member for common rotation. The output end has a plurality of second helical coils. The tang is formed on an axial side of the output end that is opposite the input end such that all of the second helical coils are disposed between the tang and the input end. The method includes: providing an actuator having a first rotary flux element, a clutch control ring and a second rotary flux element, the first rotary flux element being coupled to the drive member for common rotation and having a plurality of first teeth that are spaced circumferentially about the rotary axis, the clutch control ring being rotatable about the rotary axis and being coupled to the tang of the wrap spring, the second rotary flux element being coupled to the clutch control ring for rotation therewith about the rotary axis, the second rotary flux element having a plurality of second teeth that are spaced circumferentially about the rotary axis; and transmitting a magnetic field between the first and second teeth to cause the clutch to change from one of the first and second clutch modes to the other one of the first and second clutch modes.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary engine accessory constructed in accordance with the teachings of the present disclosure;

FIG. 2 is a front exploded perspective view of the engine accessory of FIG. 1;

FIG. 3 is a rear exploded perspective view of the engine accessory of FIG. 1;

FIG. 4 is a cross-sectional view taken along the line 4-4 of FIG. 1;

FIG. 5 is a rear elevation view of an alternately constructed portion of the engine accessory of FIG. 1, illustrating different tooth geometries on first and second rotary flux elements of an actuator;

FIG. 6 is a side view of the first and second rotary flux elements depicted in FIG. 5;

FIG. 7 is a rear elevation view of another alternately constructed portion of the engine accessory of FIG. 1, illustrating different tooth geometries on first and second rotary flux elements of an actuator; and

FIG. 8 is a side view of the first and second rotary flux elements depicted in FIG. 7.

### Corresponding reference numerals indicate corresponding parts throughout the several views of the drawings.

### DETAILED DESCRIPTION

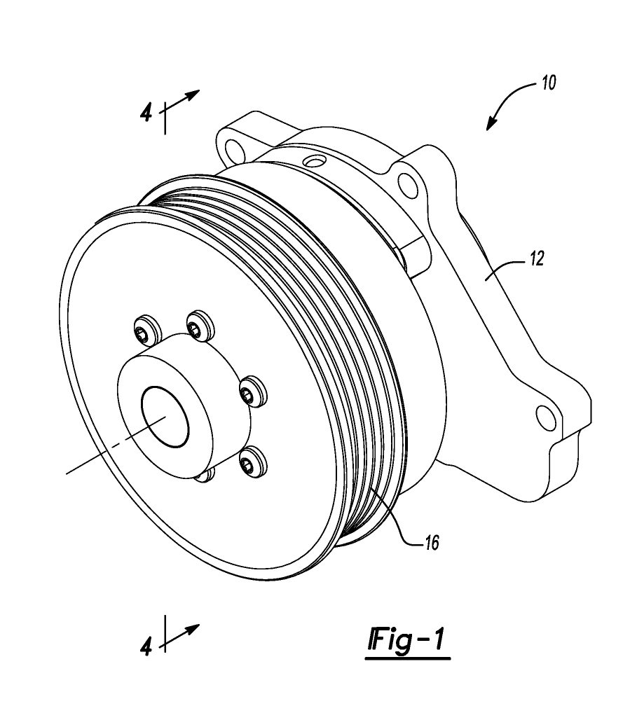

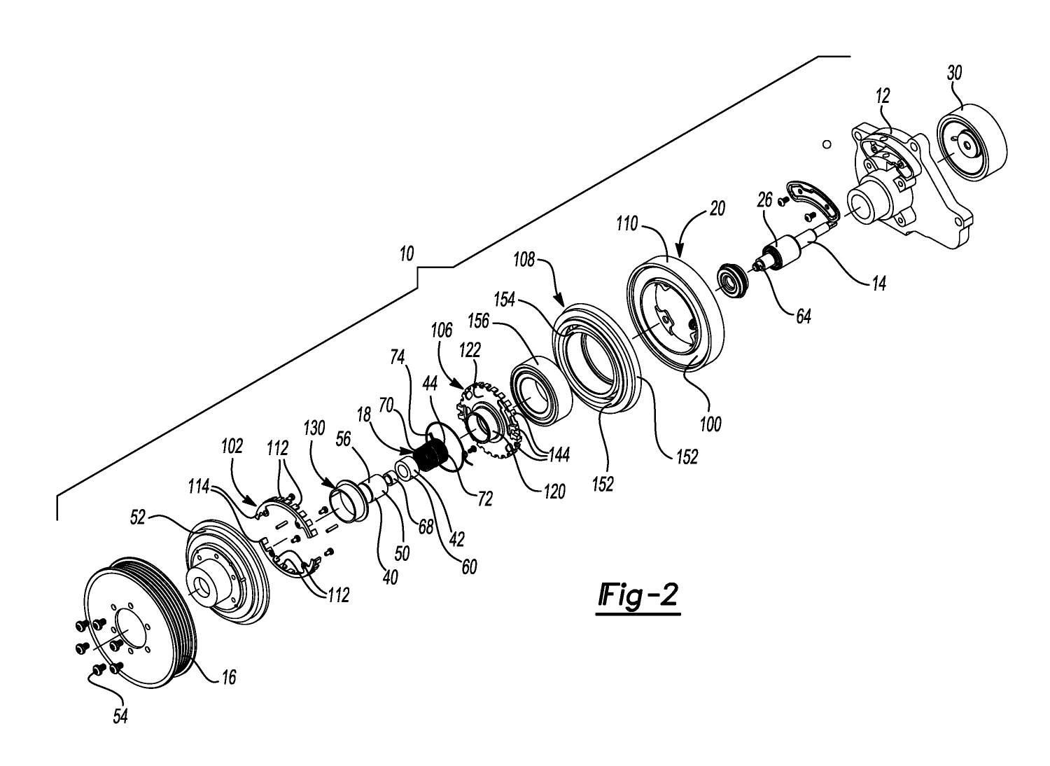

With reference to FIGS. 1 and 2, an exemplary engine accessory constructed in accordance with the teachings of the present disclosure is generally indicated by reference numeral 10. In the particular example provided, the engine accessory is depicted as a water or coolant pump, but those of skill in the art will appreciate that the present teachings have application to various other engine accessories, such as air conditioning compressors, alternators, generators, superchargers, vacuum pumps, fans and mechanical generation units.

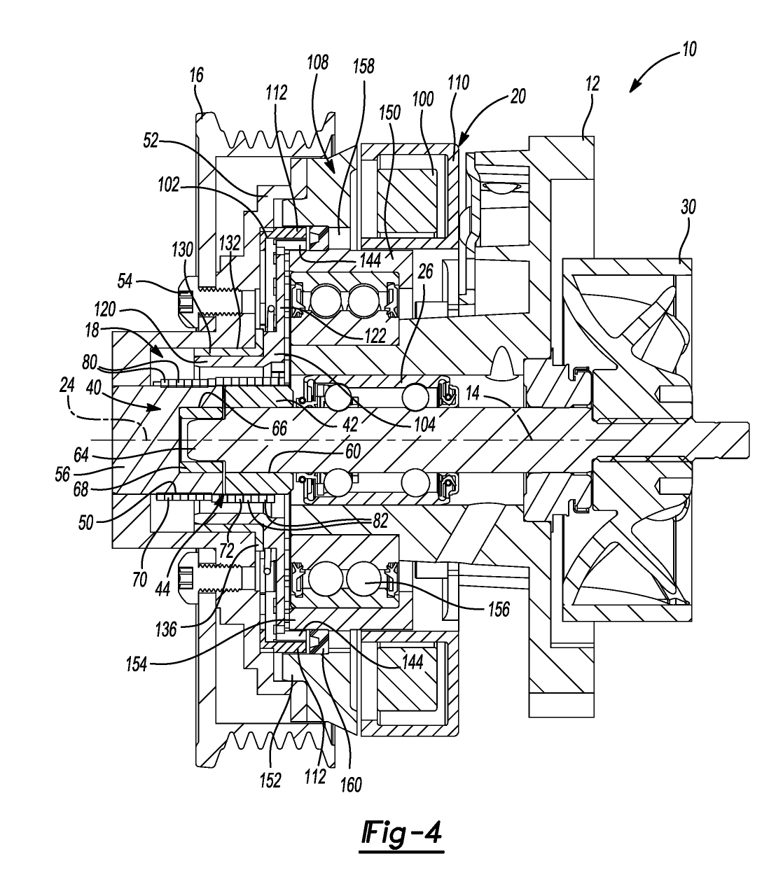

With reference to FIGS. 2 through 4, the engine accessory 10 can include a housing 12, a shaft 14, a drive member 16, a clutch 18 and an actuator 20. The housing 12 can be configured as desired to house various portions of the engine accessory 10, as well as to provide a structure that permits the engine accessory 10 to be mounted to another structure, such as an engine (not shown).

The shaft 14 can be received in the housing 12 and can be rotatable relative to the housing 12 about a rotary axis 24. A first bearing 26, which is mounted to the housing 12, supports the shaft 14 for rotation about the rotary axis 24. It will be appreciated that the shaft 14 can be the input shaft of an otherwise conventional engine accessory. In the example provided, an impeller 30 is coupled to the shaft 14 for rotation therewith.

The drive member 16 can be disposed about the shaft 14 for rotation about the rotary axis 24. The drive member 16 is configured to receive a rotary input and can be configured in any desired manner. The rotary power can be provided to the drive member 16 via an endless power transmission element (not shown), such as a belt or chain, or via meshing engagement with another element, such as a roller or a gear. In the example illustrated, the drive member 16 is a pulley that is configured to engage a belt.

The clutch 18 is configured to be operated in a first clutch mode, which permits the drive member 16 to rotate about the rotary axis 24 relative to the shaft 14 in a first rotational direction, and a second clutch mode in which the clutch 18 couples the drive member 16 to the shaft 14 for common rotation about the rotary axis 24 in the first rotational direction. The clutch 18 can include a clutch input member 40, a clutch output member 42 and a wrap spring 44. The clutch input member 40 can be coupled to the drive member 16 for common rotation about the rotary axis 24 and can have a clutch input surface 50. In the particular example provided, the clutch input member 40 comprises an input disk 52, which is removably coupled to the drive member 16 via a plurality of threaded fasteners 54 that extend through corresponding holes in the drive member 16 and threadably engage corresponding threaded holes in the input disk 52, and an input hub 56 that defines the clutch input surface 50 and is fixedly coupled to the input disk 52. The clutch output member 42 can be rotatably coupled to the shaft 14 and can define a clutch output surface 60. In the example provided, the clutch output member 42 comprises a sleeve that is fixedly coupled to the shaft 14. To aid in aligning the clutch input surface 50 and the clutch output surface 60 to one another in a concentric manner, the shaft 14 has a cylindrical projection 64 that is received into a cylindrical bore 66 formed in the clutch input member 40 and a bearing element, such as a bushing 68, can be disposed between the cylindrical projection and the cylindrical bore 66. It will be appreciated that in the alternative, a) the cylindrical projection 64 could be formed on the clutch output member 42, or that b) the cylindrical bore 66 could be formed in the clutch output member 42 or the shaft 14 and the cylindrical projection 64 could be formed on the input hub 56.

The wrap spring 44 can have an input end 70, which can be engaged to the clutch input surface 50, an output end 72, which can be drivingly engaged or engage-able to the clutch output surface 60, and a tang 74. In the example provided, the input end 70 includes a plurality of first helical coils 80 that are formed to a first diameter and drivingly engaged to the clutch input surface 50, while the output end 72 includes a plurality of second helical coils 82 that are formed to a second diameter. The second diameter can be sized relative to the clutch output surface 60 depending on the desired configuration of the clutch 18 (i.e., whether the clutch 18 is normally engaged or normally disengaged). In the illustrated embodiment, the clutch input surface 50 and the clutch output surface 60 are external cylindrical surfaces of approximately the same size and the second diameter is larger than the first diameter so that the clutch 18 operates in a normally disengaged manner (as will be discussed in more detail below). It will be appreciated, however, that the clutch input surface 50 and the clutch output surface 60 could be formed as internal cylindrical surfaces and/or that the clutch 18 could be configured to operate in a normally engaged manner. The tang 74 is formed on an axial side of the output end 72 that is opposite the input end 70 such that all of the second helical coils 82 are disposed between the tang 74 and the input end 70. In the example provided, the tang 74 extends in a radially outward direction from the second helical coils 82.

The actuator 20 can have an electromagnet 100, a first rotary flux element 102, a clutch control ring 104, a second rotary flux element 106 and a flux guide 108. The electromagnet 100 can be coupled to the housing 12 in any desired manner. In situations where the housing 12 is intended to rotate during the operation of the engine accessory 10, the electromagnet 100 can be rotatably coupled to the housing 12. In the particular example provided, the electromagnet 100 is mounted to a bracket 110 that is non-rotatably mounted to the housing 12.

The first rotary flux element 102 can be coupled to the drive member 16 for common rotation about the rotary axis 24 and can have a plurality of first teeth 112 that are spaced circumferentially about the rotary axis 24. In the example provided, the first rotary flux element 102 comprises a plurality of discrete tooth sets 114 that are mounted to the input disk 52 of the clutch input member 40.

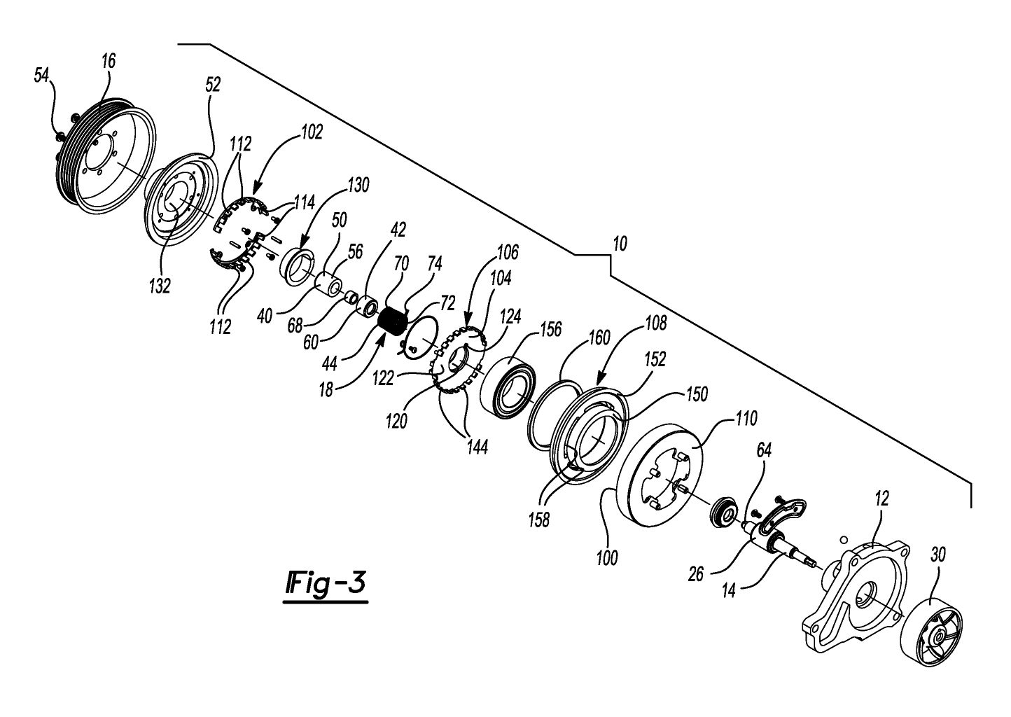

The clutch control ring 104 can be rotatable about the rotary axis 24 and can be non-rotatably coupled to the tang 74 of the wrap spring 44. In the example provided, the clutch control ring 104 includes a hub member 120 and an annular flange 122 that extends radially outwardly from the hub member 120. The annular flange 122 can define a slot 124 (best shown in FIG. 3) that is configured to receive the tang 74 of the wrap spring 44. A bushing 130 can be received between the hub member 120 and an inside circumferential surface 132 formed in the input disk 52 of the clutch input member 40. The bushing 130 and the hub member 120 are configured to cooperate with the clutch input member 40 to align the clutch control ring 104 to the rotary axis 24. The bushing 130 can include an annular portion 136 that can contact the annular flange 122 of the clutch control ring 104 to limit axial movement of the clutch control ring 104 along the rotary axis 24 in a direction toward the input disk 52.

The second rotary flux element 106 can be coupled to the clutch control ring 104 for rotation therewith about the rotary axis 24 and can have a plurality of second teeth 144 that are spaced circumferentially about the rotary axis 24. The first teeth 112 and the second teeth 144 can be disposed concentrically such that the first teeth 112 and the second teeth 144 overlap one another in an axial direction along the rotary axis 24. In the example provided, the second teeth 144 are disposed radially inwardly of the first teeth 112, but it will be appreciated that the configuration of the first teeth 112 and the second teeth 144 can be reversed such that the second teeth 144 are radially outwardly of the first teeth 112.

The flux guide 108 can be coupled to the drive member 16 for common rotation about the rotary axis 24 and can be disposed along the rotary axis 24 between the electromagnet 100 and at least one of the first teeth 112 and the second teeth 144. In the particular example provide, the flux guide 108 is fixedly coupled to the input disk 52 of the clutch input member 40. The flux guide 108 can define a bearing mount 150 and first and second circumferentially extending guide members 152 and 154, respectively. A second bearing 156 can be mounted to the housing 12 and received in the bearing mount 150 and so as to support the flux guide 108, and therefore the drive member 16, for rotation about the rotary axis 24. The second bearing 156 can overlap at least a portion of the first bearing 26 in an axial direction along the rotary axis 24. The first and second circumferentially extending guide members 152 and 154 can at least partly overlap the first teeth 112 and the second teeth 144 in an axial direction along the rotary axis 24. The first circumferentially extending guide member 152 can be disposed radially outwardly of the first teeth 112 and the second teeth 144. The second circumferentially extending guide member 154 can be disposed radially outwardly of the first teeth 112 and the second teeth 144. A plurality of windows 158 can be formed in the flux guide 108 radially between the first and second circumferentially extending guide members 152 and 154. In the example provided, each of the windows 158 extends about a portion of a circumference of the flux guide 108. If desired, a non-magnetically susceptible material, such as anelastomeric seal or a stainless steel ring 160, can be received into the flux guide 108 and can inhibit transmission of dirt, debris and moisture through the windows 158.

As noted above, the clutch 18 is configured in a normally disengaged manner so that when rotary power is provided to the drive member 16 and electric power is not provided to the electromagnet 100 (so that the electromagnet 100 does not produce a magnetic field), the clutch 18 operates in the first clutch mode. In this mode, rotation of the drive member 16 in a first rotational direction causes corresponding rotation of the clutch input member 40 as well as the first rotary flux element 102. The first helical coils 80 are grippingly engaged to the clutch input surface 50 on the clutch input member 40 and consequently, rotation of the drive member 16 in the first rotational direction causes corresponding rotation of the wrap spring 44 in the first rotational direction. Because the tang 74 of the wrap spring 44 is received into the slot 124 in the clutch control ring 104, both the clutch control ring 104 and the second rotary flux element 106 also rotate with the drive member 16 in the first rotational direction. Because the second helical coils 82 on the wrap spring 44 are larger in diameter than the clutch output surface 60, the wrap spring 44 does not drivingly engage the clutch output member 42 so that rotary power is not transmitted to the clutch output member 42 or the shaft 14. Consequently, the engine accessory 10 is inactive (i.e., does not perform its normal function, such as pumping water or coolant).

Electric power can be provided to the electromagnet 100 to generate a magnetic field that is transmitted between the first and second teeth 112 and 144 to activate the engine accessory 10 (so that it performs its normal function). More specifically, the magnetic field produced by the electromagnet 100 can be transmitted between the first and second teeth 112 and 144 to rotate the second teeth 144 into alignment with the first teeth 112. It will be appreciated that rotation of the second teeth 144 causes corresponding rotation of the clutch control ring 104 about the rotary axis 24, as well as corresponding rotation of the tang 74 of the wrap spring 44. This rotational movement of the tang 74 initiates engagement of the second helical coils 82 with the clutch output surface 60 so that some rotary power is transmitted between a portion of the second helical coils 82 and the clutch output member 42. Due to the (rotational) direction in which the wrap spring 44 is wound, the transmission of rotary power through the portion of the second helical coils 82 has a cascading effect that drives all of the second helical coils 82 into full driving engagement with the clutch output surface 60. In this condition, rotary power from the drive member 16 is transmitted through the clutch 18 to the shaft 14 to drive the impeller 30.

It will be appreciated from the configuration of the flux guide 108 that the magnetic field produced by the electromagnet 100 will be transmitted along a path that includes a first axially-directed segment, in which the magnetic flux passes in an axial direction through the flux guide 108 away from the electromagnet 100, a radially-directed segment, in which the magnetic flux passes radially through the first circumferentially extending guide member 152, the first teeth 112, the second teeth 144 and the second circumferentially extending guide member 154, and a second axially-directed segment in which the magnetic flux passes in an axial direction through the bearing mount 150 toward the electromagnet 100.

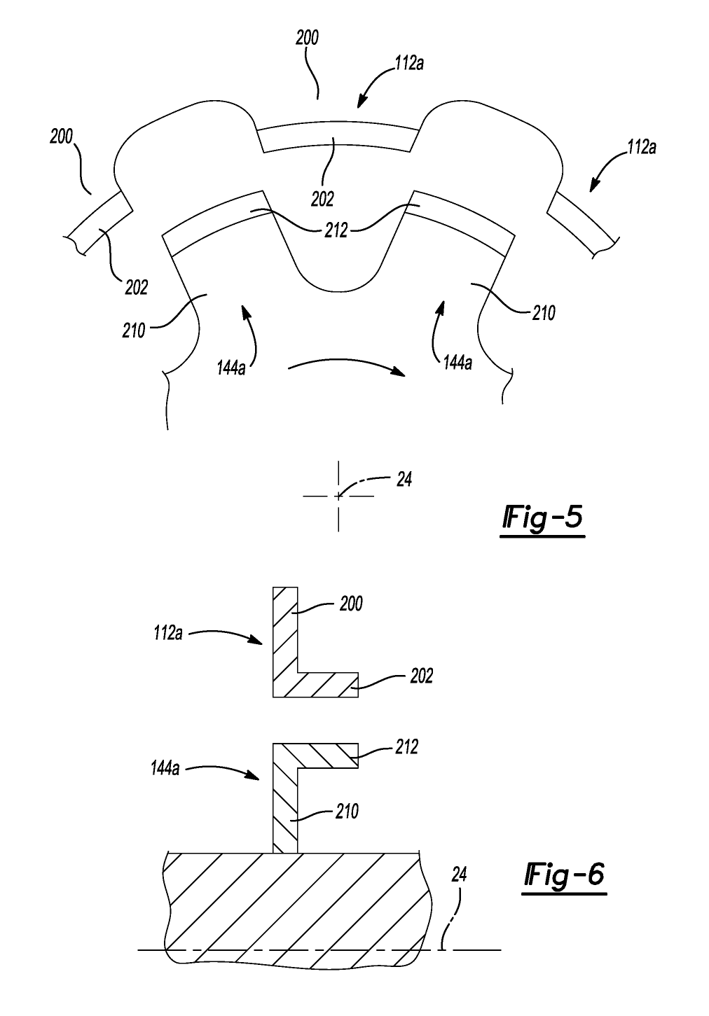

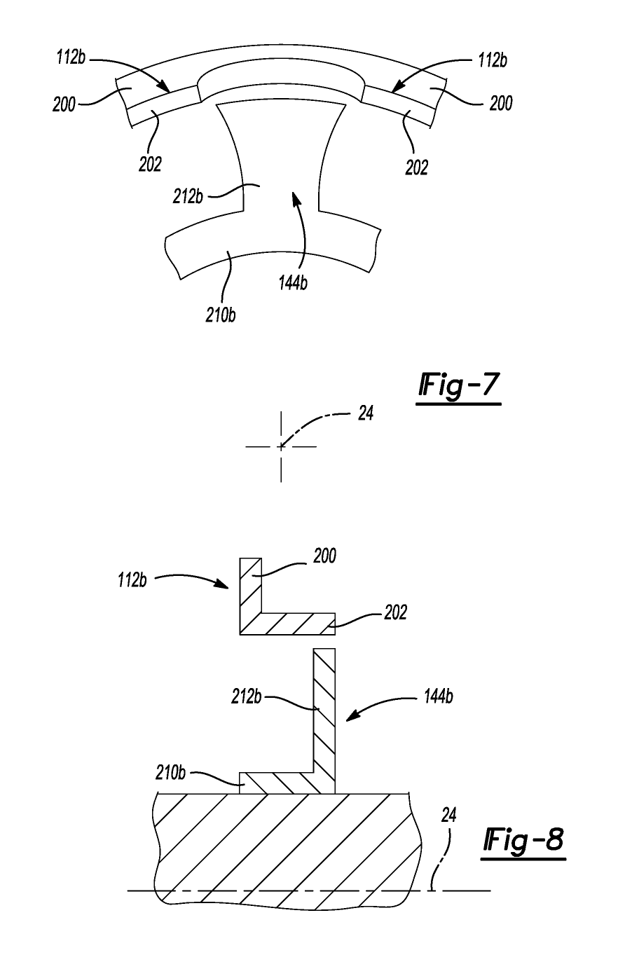

While the first teeth 112 and the second teeth 144 have been illustrated and described as being spaced circumferentially about the rotary axis 24 and overlapping one another in an axial direction along the rotary axis 24, it will be appreciated that the first and second teeth 112 and 114 could be formed somewhat differently. For example, the first and second teeth 112a and 144a, respectively, could be formed as shown in FIGS. 5 and 6. In this example, the first teeth 112a are generally L-shaped, having a first leg 200, which can extend in a radial direction relative to the rotary axis 24 (e.g., radially inwardly), and a second leg 202 that can extend in an axial direction from the first leg 200 (e.g., radially inwardly) parallel or concentric to the rotary axis 24. Similarly, the second teeth 144a are generally L-shaped, having a first leg 210, which can extend in a radial direction relative to the rotary axis 24 (e.g, radially outwardly), and a second leg 212 that can extend axially from the first leg 210 parallel to or concentric with the rotary axis 24. The first and second teeth 112a and 144a are configured such that the second legs 202 and 212 are spaced apart from one another but are faced in opposition with one another. As another example, the first and second teeth 112b and 144b, respectively, could be formed as shown in FIGS. 7 and 8. In this example, the first teeth 112b are generally similar to the first teeth 112a (FIG. 6), and as such will not be discussed in significant detail herein. The second teeth 144b, however, are generally L-shaped, having a first leg 210b, which can extend in an axial direction along the rotary axis 24, and a second leg 212b that can extend in a radial direction relative to the rotary axis 24 from the first leg 210b in a direction toward the second leg 202 of an associated one of the first teeth 112b. The first and second teeth 112b and 144b are configured such that the second legs 202 and 212b are spaced apart from one another but an axial end of the second leg 212b, which has a relatively small surface area, is faced in opposition with the relatively larger surface of the second leg 202 of the first teeth 112b. If desired, the configuration of the first teeth 112b and the second teeth 144b could be reversed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An engine accessory comprising:
a housing;
a shaft received in the housing and rotatable relative to the housing about a rotary axis;
a drive member disposed about the shaft for rotation about the rotary axis;
a clutch that is operable in a first clutch mode, which permits rotation of the drive member relative to the shaft in a first rotational direction, and a second clutch mode in which the shaft is coupled to the drive member for common rotation about the rotary axis, the clutch having a wrap spring with an input end, an output end and a tang, the input end comprising a plurality of first helical coils that are drivingly engaged to a clutch input surface that is coupled to the drive member for common rotation, the output end having a plurality of second helical coils, the tang being formed on an axial side of the output end that is opposite the input end such that all of the second helical coils are disposed between the tang and the input end; and
an actuator having a first rotary flux element, a clutch control ring, a second rotary flux element, and an electromagnet, the first rotary flux element being coupled to the drive member for common rotation and having a plurality of first teeth that are spaced circumferentially about the rotary axis, the clutch control ring being rotatable about the rotary axis and being coupled to the tang of the wrap spring, the second rotary flux element being coupled to the clutch control ring for rotation therewith about the rotary axis, the second rotary flux element having a plurality of second teeth that are spaced circumferentially about the rotary axis, the electromagnet being selectively operable to generate a magnetic field that is transmitted between the first and second teeth.

2. The engine accessory of claim 1, wherein the second teeth are disposed concentric with the first teeth such that at least a portion of the first teeth and at least a portion of the second teeth overlap one another in an axial direction along the rotary axis.

3. The engine accessory of claim 2, wherein the first teeth extend along the rotary axis in their entirety, and wherein the second teeth extend along the rotary axis in their entirety.

4. The engine accessory of claim 3, wherein the first teeth, or the second teeth, or both the first teeth and the second teeth are generally L-shaped.

5. The engine accessory of claim 2, wherein the second teeth are disposed radially inwardly of the first teeth.

6. The engine accessory of claim 1, wherein the actuator further comprises a flux guide that is disposed between the electromagnet and at least one of the first teeth and the second teeth.

7. The engine accessory of claim 6, wherein the flux guide has first and second circumferentially extending guide members that at least partly overlap the first and second teeth in an axial direction along the rotary axis, wherein the first circumferentially extending guide member is disposed radially inwardly of the first and second teeth, and wherein the second circumferentially extending guide member is disposed radially outwardly of the first and second teeth.

8. The engine accessory of claim 6, wherein a plurality of windows are formed in the flux guide, each of the windows extending about a portion of a circumference of the flux guide.

9. The engine accessory of claim 6, wherein the flux guide is coupled to the drive member for common rotation about the rotary axis.

10. The engine accessory of claim 1, wherein the clutch input surface is an outer diametrical surface.

11. The engine accessory of claim 10, wherein the second helical coils are configured to engage a clutch output surface when the clutch is operated in the second clutch mode, the clutch output surface being coupled to the shaft for common rotation about the rotary axis.

12. The engine accessory of claim 1, wherein the second helical coils are configured to engage a clutch output surface when the clutch is operated in the second clutch mode and wherein the second helical coils are configured to disengage the clutch output surface when the magnetic field is not produced by the electromagnet.

13. The engine accessory of claim 12, wherein the first helical coils are formed to a first diameter, wherein the second helical coils are formed to a second diameter and wherein the first diameter is smaller than the second diameter.

14. The engine accessory of claim 1, wherein the drive member is configured to engage an endless power transmission element.

15. The engine accessory of claim 14, wherein the drive member is a pulley.

16. The engine accessory of claim 1, further comprising an impeller coupled to the shaft for rotation therewith.

17. The engine accessory of claim 1, further comprising first and second bearings, wherein the first bearing is mounted to the housing and supports the drive member for rotation about the rotary axis, wherein the second bearing is mounted to the housing and supports the shaft for rotation about the rotary axis, and wherein the first bearing overlaps at least a portion of the second bearing in an axial direction along the rotary axis.

18. The engine accessory of claim 1, wherein the electromagnet is non-rotatably coupled to the housing.

19. The engine accessory of claim 1, wherein the tang extends radially outwardly from the second helical coils.

20. The engine accessory of claim 1, wherein a bushing is disposed between the clutch input surface and the shaft.

21. The engine accessory of claim 1, wherein the first rotary flux element comprises a plurality of discrete tooth sets that are fixedly coupled to the drive member.

22. A method for operating an engine accessory having a housing, a shaft, a drive member and a clutch, the shaft being received in the housing and being rotatable relative to the housing about a rotary axis, the drive member being disposed about the shaft for rotation about the rotary axis, the clutch being operable in a first clutch mode, which permits rotation of the drive member relative to the shaft in a first rotational direction, and a second clutch mode in which the shaft is coupled to the drive member for common rotation about the rotary axis, the clutch having a wrap spring with an input end, an output end and a tang, the input end comprising a plurality of first helical coils that are drivingly engaged to a clutch input surface that is coupled to the drive member for common rotation, the output end having a plurality of second helical coils, the tang being formed on an axial side of the output end that is opposite the input end such that all of the second helical coils are disposed between the tang and the input end, the method comprising:
providing an actuator having a first rotary flux element, a clutch control ring and a second rotary flux element, the first rotary flux element being coupled to the drive member for common rotation and having a plurality of first teeth that are spaced circumferentially about the rotary axis, the clutch control ring being rotatable about the rotary axis and being coupled to the tang of the wrap spring, the second rotary flux element being coupled to the clutch control ring for rotation therewith about the rotary axis, the second rotary flux element having a plurality of second teeth that are spaced circumferentially about the rotary axis; and
transmitting a magnetic field between the first and second teeth to cause the clutch to change from one of the first and second clutch modes to the other one of the first and second clutch modes.
